(19) United States
(12) Patent Application Publication
(10) Pub. No.: US 2008/0258398 A1
(43) Pub. Date: Oct. 23, 2008

(54) SEAL

(76) Inventors: Mark S. Whitlow, Columbia, SC (US); Jeff Farris, Raleigh, NC (US)

Correspondence Address: HOLLAND & HART, LLP, P.O BOX 8749, DENVER, CO, 80201, US

(21) Appl. No.: 12/057,201

(22) Filed: Mar. 27, 2008

Related U.S. Application Data
(60) Provisional application No. 60/909,196, filed on Mar. 30, 2007.

(51) Int. Cl. F16J 15/02

(52) U.S. Cl. 277/312; 277/644; 277/647

(57) ABSTRACT

The technology of the present application provides seal to be engaged between a fitting and a port to prevent leaking of media passing through the fitting and port. The seal includes upper and lower protruding portions that are compressible and deformable to provide higher sealing forces and an air tight seal at standard industry torque and compression load values.

This application claims the benefit of priority to U.S. Provisional Application No. 60/909,196, filed Mar. 30, 2007, the entirety of which is herein incorporated by reference.

### BACKGROUND

1. Field

The technology of the present application relates to seals, and more specifically, to seals for ports or glands.

2. Background

Assorted systems may use fluids or gases (generally referred to as “media” or “process media”) to maintain pressure. These pressurized systems often have ports and fittings to allow the introduction of media to charge the system. It is generally necessary to provide a seal between any port and fitting in the system to prevent pressure loss by the escape of some or all of the media passing through the port or fitting.

Ports traditionally include machined, internally threaded passages, while fittings traditionally include external threads that mate with the threaded passages of the port. The threads of the port matingly receive the threads of the fitting to form a joint, where closing of the joint is accomplished by applying an appropriate torque to the fitting aligned with the port.

When a seal is employed between the fitting and port, the joint formed is closed to prevent leakage of media and pressure drops. As shown in FIG. 1, a fitting 20 passes through an opening 15 in a traditional seal 10, causing the seal 10 to be held in place between the fitting 20 and the port 30. As the fitting 20 is tightened within the port 30, the seal 10 is compressed between the fitting 20 and the port 30, thereby providing a seal to prevent process media from escaping or entering the system and to prevent a pressure loss within the system. Such a traditional seal may not provide adequate sealing force at traditional industry torque values and may fail at extreme operating temperatures and pressures.

Some seals known in the art, such as seal 50 illustrated in FIG. 2, may maintain a seal even in the face of irregular surfaces on the fitting 60 and/or port 70. The seal 50 includes first flexible sealing arm 52 extending diagonally upward and away from a main portion 56 of the seal and a second flexible sealing arm 54 extending diagonally downward and away from the main portion 56. Both the first sealing arm 52 and the second sealing arm 54 are thin relative to the thickness of the main portion 56. Accordingly, these seals 50 are expensive to manufacture due to the intricacies associated with machining thin sealing arms. Additionally, the thin sealing arms are fragile and are therefore prone to break when excessive compression is applied to the seal or even when handled or transported improperly.

Accordingly, a seal for providing a bubble tight seal between a port and fitting without requiring high levels of torque and which is not expensive to manufacture or prone to breaking is desirable.

### SUMMARY

Embodiments disclosed herein address the above stated needs by providing an annular seal having an upper protruding portion protruding upwardly from the portion of the seal body proximate the opening in the seal and a lower protruding portion protruding downwardly from the portion of the seal body proximate the opening in the seal and in a direction perpendicular to the lower annular-shaped surface of the seal body.

The foregoing, as well as other features, utilities, and advantages of the invention will be apparent from the following more particular description of a preferred embodiment of the invention as illustrated in the accompanying drawings.

### BRIEF DESCRIPTION OF THE DRAWINGS

FIG. 1 shows a cross-section of a first prior art seal engaged between a fitting and a port;

FIG. 2 shows a cross-section of a second prior art seal engaged between a fitting and a port;

FIG. 3 shows a top-down view of a seal according to one embodiment of the present invention;

FIG. 4 shows a cross-section of a seal according to one embodiment of the present invention;

FIG. 5 shows a blown-up view of the area inside circle A in FIG. 4;

FIG. 6 shows a cross-section of a seal according to one embodiment engaged between a fitting and a port;

FIG. 7 shows a blown-up view of the area inside circle B in FIG. 6.

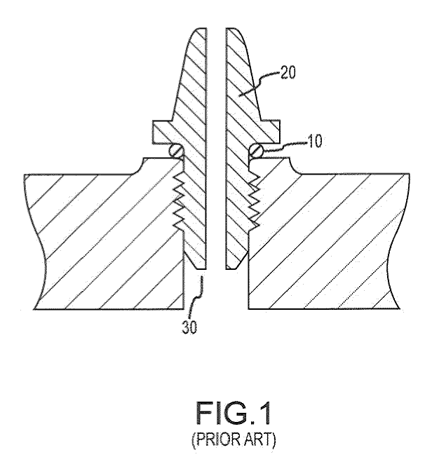

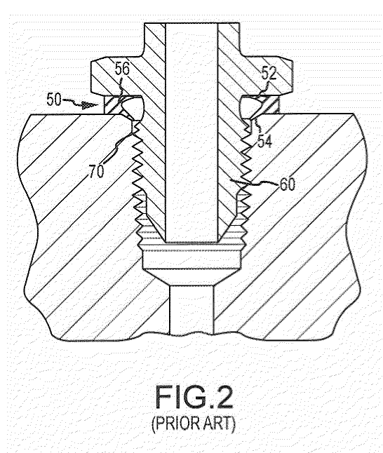

### DETAILED DESCRIPTION

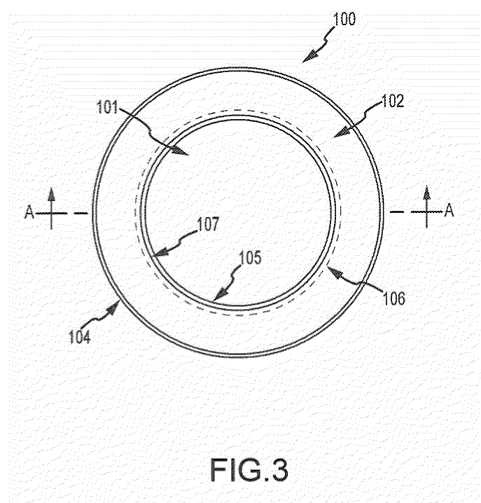

The technology of the present application will be further explained with reference to FIGS. 3 through 7. FIG. 3 shows a top-down view of a seal according to a first embodiment of the present invention. The seal 100 has a substantially annular shape, with an aperture 101 extending through the middle of the seal 100. The seal 100 has an upper face 102 and a lower face 103 opposite the upper face. In one aspect of the embodiment, the upper face 102 and lower face lie in parallel planes. The seal also includes an outer wall 104 and an inner wall 105, which may be aligned concentrically. In one embodiment, the outer wall 104 and inner wall 105 are perpendicular to the upper face 102 and lower face. A groove 106 extends into the inner wall 105 of the seal 100. An upper protruding portion 107 protrudes upwardly from the upper face 102 proximate an inner edge of the upper face 102.

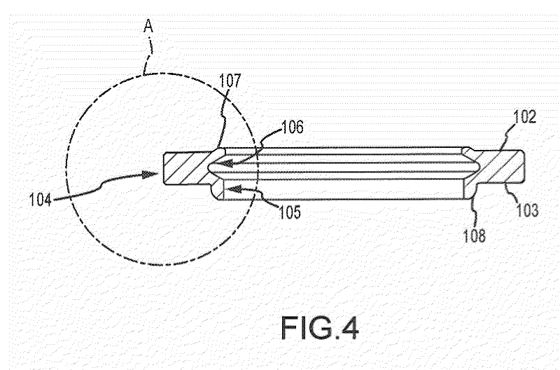

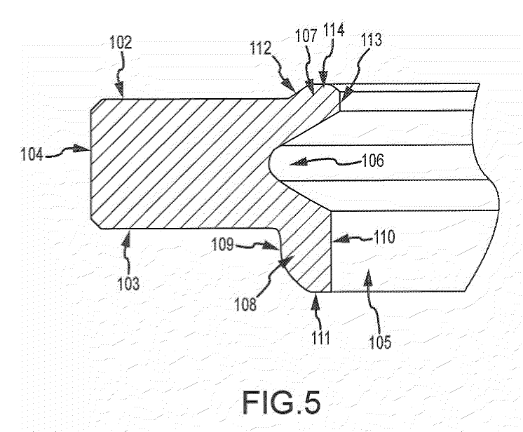

FIGS. 4 and 5 illustrates a cross section of the seal 100. Upper face 102 opposes lower face 103 and, as illustrated, the upper face 102 and lower face 103 lie in parallel planes. However, in an alternate configuration, the upper surface and lower surface may lie in planes that are not parallel. Outer wall 104 opposes inner wall 105, and, as illustrated, each of the outer wall 104 and inner wall 105 are aligned perpendicular to the upper face 102 and lower face 103 and the inner wall 105 lies in a parallel plane to the outer wall 104. However, in alternate configurations, the outer wall 104 and inner wall 105 need not be perpendicular to the upper face 102 and lower face 103, and the outer wall 104 and inner wall 105 need not lie in parallel planes.

The inner wall 105 includes a groove 106, which, as illustrated, is centered on the inner wall 105 between the upper face 102 and lower face 103. In one aspect of the embodiment, the groove has a V-shape. Other shapes, such as a U-shape, also may be used in the seal of the instant application. In one aspect of the embodiment described herein, the size of the mouth of the groove 106 is substantially equal to the distance between the upper face 102 and the lower face 103. However, the size of the mouth of the groove 106 may be smaller or larger than the distance between the upper face 102 and lower face 103. The depth of the groove 106, i.e., the distance into the inner wall 105 the groove 106 penetrates, also may vary. In one embodiment, the depth that the groove 106 extends into the inner wall 105 is farther than the location where the protruding portions, discussed in greater detail below, begin.

As also shown in FIGS. 4 and 5, the seal 100 includes the upper protruding portion 107 and the lower protruding portion 108. The upper protruding portion 107 is located on the upper face 102 proximate the inner wall 105, and may extend all the way to the inner wall 105. In an alternate aspect, the upper protruding portion 107 may extend to just before or just beyond the inner wall 105. The lower protruding portion 108 is located on the lower face 103 proximate the inner wall 105 and may extend all the way to the inner wall 105. In an alternate aspect, the lower protruding portion 108 may extend to just before or just beyond the inner wall 105. In the case of the upper protruding portion 107, the upper protruding portion 107 may rise from the location on the upper face 102 proximate the inner wall 105 to a height above the upper face 102. In the case of the lower protruding portion 108, the lower protruding portion 108 may extend away from the location on the lower face 103 proximate the inner wall 105 to a distance below the lower face 103.

As illustrated in FIG. 5, the upper protruding portion 107 extends away from the upper face 102. The upper protruding portion 107 includes an outside wall 112 and an inside wall 113. The outside wall 112 and inside wall 113 may be perpendicular to the upper face 102 or the outside wall 112 and inside wall 113 may be other than perpendicular to the upper face 102. In FIG. 5, outside wall 112 is not perpendicular to the upper face 102 while inside wall 113 is perpendicular to the upper face 102. While FIG. 5 illustrates an outside wall 112 and an inside wall 113 that are not parallel to each other, in an alternate aspect, the outside wall 112 and inside wall 113 may be parallel to each other. The upper protruding portion 107 also includes an end wall 114. The end wall 114 of the upper protruding portion 107 may be substantially parallel to the upper face 102 and meets the inside wall 113 and outside wall 112 of the upper protruding portion 107 at either a right angle or a rounded corner. In one aspect of the embodiment, both the outside wall 112 and inside wall 113 meet the end wall 114 at rounded corners.

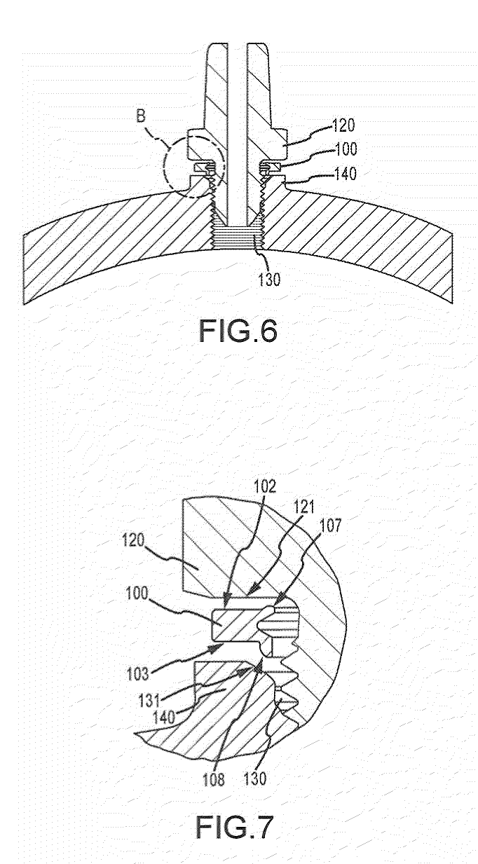

As also illustrated in FIG. 5, the lower protruding portion 108 extends away from the lower face 103 in a direction perpendicular to the lower face 103. That is to say, lower protruding portion 108 includes an outside wall 109 and an inside wall 110, wherein both the outside wall 109 and inside wall 110 extend away ftom the lower face 103 in a direction perpendicular to the lower face 103. While outside wall 109 and inside wall 110 are shown perpendicular to the lower face 103, outside wall 109 and inside wall 110 may be other than perpendicular to lower face 103. Moreover, outside wall 109 and inside wall 110 are not necessarily parallel to each other. The lower protruding portion 108 also includes an end wall 111. The end wall 111 of the lower protruding portion 108 may be substantially parallel to the lower face 103 and meets the inside wall 110 and outside wall 109 of the lower protruding portion 108. In one aspect of the embodiment, the inside wall 110 meets the end wall 111 at a right angle, while the outside wall 109 and the end wall 111 meet at a rounded corner. Similarly, the outside wall 109 and the lower face 103 may meet at a rounded corner. The rounded corners at the intersection of the outside wall 109 and the lower face 103 and the outside wall 109 and the end wall 111 may allow the seal to better engage with the port where the port edges also have rounded corners (see, for example, FIGS. 6 and 7).

As noted above, in one aspect of the embodiment described herein, the upper protruding portion 107 and lower protruding portion 108 are located entirely above and below, respectively, the groove 106. In other words, the distance from the inner wall 105 to the point at which the upper protruding portion 107 and lower protruding portion 108 begin to protrude from the upper face 102 and lower face 103, respectively, is shorter than the distance the groove 106 extends into the inner wall 105.

In the illustrated aspect of the embodiment described herein, the lower protruding portion 108 protrudes away from the lower face 103 further than the upper protruding portion 107 protrudes away from the upper face 102. In other words, the relative height of the lower protruding portion 108 is taller than the relative height of the upper protruding portion 107.

Turning now to FIGS. 6 and 7, an embodiment of the seal is depicted in application. Specifically, FIGS. 6 and 7 illustrate the use of the seal in a boss application. However, the seal may also be used in other applications, such as when the port is on a planar surface.

FIGS. 6 and 7 illustrate a fitting 120 passing through the center aperture of the seal 100 and engaging with the port 130. As shown in FIGS. 6 and 7, the port 130 is part of a boss 140. The fitting 120 has male threads for engaging with the female threads of the port 130 and securing the fitting 120 to the port 130. The seal 100 ensures that media passing through the port 130 and fitting 120 will not escape at the juncture of the fitting 120 and port 130.

As best shown in FIG. 7, the upper face 102 and the upper protruding portion 107 of the seal 100 come into contact with a surface 121 of the fitting 120, while the lower face 103 and the lower protruding portion 108 come into contact with a surface 131 of the port 130. As the fitting 120 is engaged further with the port 130, the upper protruding portion 107 and lower protruding portion 108 are compressed and deform to form a media tight seal between the fitting 120 and port 130. The main portion of the seal 100 between the upper face 102 and lower face 103 serves a mechanical stop due its thickness.

Because the upper protruding portion 107 and lower protruding portion 108 are elastic and located above or below the groove 106, the upper protruding portion 107 and lower protruding portion 108 may compress and deform to form a bubble tight seal when torque and compressive load are applied to screw the fitting 120 into the port 130. Additionally, only standard industry torque and compressive load values need be applied to create higher contact stresses (i.e., sealing forces). Thus, under standard industry torque and compressive load values, the seal of the instant application is capable of creating higher contact stresses (i.e., sealing forces) than conventional seals and a bubble tight seal. Additionally, due to the orientation and size of the lower protruding portion 108, the sealing forces are localized on the conical surface of the port 130, which allows for tighter control of leakage.

In order to provide additional deformation and effect a tighter seal between the fitting 120 and port 130, the seal 100 may be plated with a ductile plating. The plating will plastically deform into features or imperfections on the surfaces of the fitting or port. The plating may be any suitable ductile plating, such as gold, nickel or silver. The plating may be located on every surface of the seal or, in an alternate configuration, on just the upper protruding portion 107 and lower protruding portion 108. The thickness of the plating layer, whether all over the seal or on only the upper protruding portion and lower protruding portion, may be any suitable thickness for the application in which the seal is used. In one aspect of the embodiment, the thickness of the plating is between about 0.0001 and 0.0010 inches. The plating thickness may also vary at different points on the same seal. In one aspect of the embodiment described herein, the seal may include a first plating layer and a second plating layer, the first and second plating layers being different ductile materials.

In order to withstand high temperature and high pressure operations, the seal comprises high-strength, heat resistant alloy. The alloy may be a steel alloy, nickel alloy or any other suitable metallic or non-metallic material.

The seal may be formed from one integral piece of material. That is to say, all parts of the seal are machined from a single piece of material without the need to attach portions of the seal (such as the lower protruding portion) via welding, soldering or other means of attachment.

In one aspect of the embodiment, the groove 106 of the seal 100 is adapted such that the groove 106 receives a thread of the fitting 120. In other words, the fitting 120 is screwed into the port 130 such that a thread of the fitting 120 resides in the groove 106 of the seal 100. The thread of the fitting 120 and groove 106 may have corresponding shapes, such as a V-shaped groove 106 and a V-shaped thread of the fitting 120. In this aspect, the lower protruding 108 portion will be flattened between a thread of the port 130 and a thread of the fitting 120 located below the thread of the fitting 120 residing in the groove 106. The ductility of the lower protruding portion 108 as described above allows for the deformation and flattening of the lower protruding portion 108 between the threads. In a specific aspect, an upper thread or the most uppermost thread of the fitting 120 resides in the groove such that the majority of the fitting 120 may be screwed into the port 130. Such a configuration further assists in effecting a seal between the port 130 and the fitting 120.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An annular seal comprising:
a main seal body having an upper face, a lower face opposite the upper face, an outer wall and an inner wall opposite the outer wall, wherein a groove extends into the inner wall of the main seal body;
an upper protruding portion protruding upwardly from the portion of the upper face of the main seal body closest to the inner wall to a position higher than the upper face; and
a lower protruding portion protruding downwardly from the portion of the lower face of the main seal body closest to the inner wall in a direction perpendicular to the lower face to a position below the lower face.

2. The annular seal as claimed in claim 1, wherein the upper face and the lower face lie in parallel planes.

3. The annular seal as claimed in claim 1, wherein the groove comprises a V-shaped groove.

4. The annular seal as claimed in claim 1, wherein the groove comprises a U-shaped groove.

5. The annular seal as claimed in claim 1, wherein main seal body has a thickness and a size of a mouth of the groove is substantially equal to the thickness of the main seal body.

6. The annular seal as claimed in claim 1, wherein main seal body has a thickness and a size of a mouth of the groove is not equal to the thickness of the main seal body.

7. The annular seal as claimed in claim 1, wherein the upper protruding portion and the lower protruding portion are located entirely above and below, respectively, the groove.

8. The annular seal as claimed in claim 1, wherein the lower protruding portion protrudes farther away from the lower face than the upper protruding portion protrudes away from the upper face.

9. The annular seal as claimed in claim 1, wherein the lower protruding portion comprises an outside wall and an inside wall, each of the outside wall and inside wall aligned perpendicular to the lower face of the main seal body.

10. The annular seal as claimed in claim 9, wherein the lower protruding portion further comprises a end wall, the end wall meeting the outside wall at a rounded corner and the inside wall at a right angle.

11. The annular seal as claimed in claim 1, wherein the material of the annular seal is a metal alloy.

12. The annular seal as claimed in claim 11, wherein the metal alloy is selected from the group consisting of a steel alloy and a nickel alloy.

13. The annular seal as claimed in claim 1, wherein the upper protruding portion and the lower protruding portion are plated with a metal.

14. The annular seal as claimed in claim 13, wherein the metal is selected from the group consisting of gold and silver.

15. The annular seal as claimed in claim 1, wherein the groove is adapted to receive a male thread of a fitting when the seal is engaged between the fitting and a port.

16. An annular seal comprising:
a main seal body having an upper face, a lower face opposite the upper face, an outer wall and an inner wall opposite the outer wall, wherein a groove extends into the inner wall of the main seal body;
means for sealing protruding upwardly from the portion of the upper face of the main seal body closest to the inner wall to a position higher than the upper face; and
means for sealing protruding downwardly from the portion of the lower face of the main seal body closest to the inner wall in a direction perpendicular to the lower face to a position below the lower face.

17. A method of forming a seal between a fitting and port comprising:
providing an annular seal, the annular seal comprising:
a main seal body having an upper face, a lower face opposite the upper face, an outer wall and an inner wall opposite the outer wall, wherein a groove extends into the inner wall of the main seal body;
an upper protruding portion protruding upwardly from the portion of the upper face of the main seal body closest to the inner wall to a position higher than the upper face; and
a lower protruding portion protruding downwardly from the portion of the lower face of the main seal body closest to the inner wall in a direction perpendicular to the lower face to a position below the lower face;
engaging the seal with a fitting;
engaging the fitting with a port and;
inserting the fitting into the port until the seal is compressed between the port and the fitting such that the upper protruding portion and lower protruding portion compress and deform against the fitting and port, respectively, to form a seal.

18. The method of forming a seal as claimed in claim 17, wherein the fitting comprises male threads and the port comprises female threads and inserting the fitting into the port comprises screwing the fitting into the port.

19. The method of forming a seal as claimed in claim 18, wherein the fitting is screwed into the port such that a thread of the fitting resides in the groove of the seal.

20. The method of forming a seal as claimed in claim 17, wherein the upper protruding portion and lower protruding portion are plated with a metal.
